(19) United States
(12) Patent Application Publication
(10) Pub. No.: US 2018/0361554 A1
(43) Pub. Date: Dec. 20, 2018

(54) Portable Machine Tool and Method for Manufacturing a Portable Machine Tool

(71) Applicant: Robert Bosch GmbH, Stuttgart (DE)

(72) Inventors: Andre Ullrich, Leinfelden-Echterdingen (DE); Christian Lang, Stuttgart (DE); Andreas Schlegel, Leinfelden-Echterdingen (DE)

(21) Appl. No.: 16/062,903

(22) PCT Filed: Dec. 8, 2016
(86) PCT No.: PCT/EP2016/080183

§ 371 Date: Jun. 15, 2018

(30) Foreign Application Priority Data
Dec. 22, 2015 (DE) 10 2015 226 448.3

(51) Int. Cl. B25D 17/08; B25F 5/02; B25D 16/00

(52) U.S. Cl. CPC B25D 17/08; B25D 2250/051; B25D 16/00; B25F 5/02

(57) ABSTRACT

A portable machine tool, particularly a hammer drill and/or chisel hammer, has a length, a width, a height and a mass. The portable machine tool has at least one energy storage unit that has a charge carrier capacity and a quick-change tool holder for quick-change tools with a shaft diameter of less than 12 mm. A product formed from the length, the width, the height, the mass and the inverse of the charge carrier capacity is less than 1301 cm³ kg A h⁻¹.

### PRIOR ART

Portable battery-powered drills and battery-powered chisel hammers with quick-change tool holders for quick-change tools with a specific shaft diameter are already known from the prior art. A size, weight and battery capacity of the machines varies, machines which have a quick-change tool holder for quick-change tools with a large shaft diameter normally being constructed to be larger and heavier than machines which have a quick-change tool holder for quick-change tools with a small shaft diameter.

### DISCLOSURE OF THE INVENTION

The invention is based on a portable machine tool, in particular a hammer drill and/or chisel hammer, which has a length, a width, a height and a mass, having at least one energy storage unit which has a charge carrier capacity, and having a quick-change tool holder for quick-change tools with a shaft diameter of less than 12 mm, in particular 10 mm or of 6.5 mm.

It is proposed that a product formed from the length, the width, the height, the mass and the inverse of the charge carrier capacity be less than 1301 cm³ kg A h⁻¹.

As a result of the configuration according to the invention of the portable machine tool, in particular good handleability can be achieved. Advantageously, a machine tool having a beneficial combination of size, weight and charge carrier capacity can be provided. In addition, high operating convenience can advantageously be achieved. In particular, a machine tool having advantageously balanced handiness and running time can be provided. Furthermore, a machine tool that can be handled conveniently and/or safely and/or precisely for tools with a small shaft diameter can advantageously be provided.

“Provided” is in particular to be understood to mean specifically programmed, designed and/or equipped. The fact that an object is provided for a specific function is in particular to be understood to mean this object fulfills and/or carries out a specific function in at least one application and/or operating state. In this connection, “portable machine tool” is to be understood in particular to mean a machine processing workpieces but advantageously a drill, a hammer drill and/or percussion hammer, a chisel hammer, a saw, a plane, a screwdriver, a mill, a grinder, an angle grinder, a garden appliance and/or a multifunctional tool. The portable machine tool preferably has at least one drive unit. In this connection, “drive unit” is in particular to be understood to mean a unit which is provided to produce at least one drive torque and to provide the same to be passed on in particular to an application tool. The drive unit preferably comprises an electric motor.

Advantageously, the energy storage unit has at least one battery, particularly advantageously at least one rechargeable battery, such as a battery pack. Particularly advantageously, the energy storage unit is formed as a battery pack. Preferably, the portable machine tool has at least one interface which is provided for an in particular mechanical and/or electrical connection to the energy storage unit, in particular without tools and/or by an operator. Preferably, the energy storage unit is provided for use with an operating voltage of 18 V. However, it is also conceivable that the energy storage unit is provided for use with an operating voltage of 9 V or 24 V or 36 V or another operating voltage appearing practical to one skilled in the art. In this connection, “charge carrier capacity” is in particular to be understood to mean a rated charge.

In this connection, “quick-change tool holder” is in particular to be understood to mean a tool holder for the detachable fastening of an application tool to the electric hand-held machine tool, which in particular can be formed to be operable without tools. The quick-change tool holder is preferably provided to hold an application tool with a tool shaft belonging to an insertion system, in particular with an SDS® shaft. In this connection, “tool shaft” is in particular to be understood to mean a sub area of the application tool which, at least substantially, preferably completely, is designed free of any machining geometry, in particular cutting geometry. The tool shaft of the application tool is preferably provided for coupling the application tool to the tool holder of the electric hand-held machine tool. In this connection, “quick-change tool” is in particular to be understood to mean an application tool which is provided for fastening, in particular without tools, in and/or to a quick-change tool holder. Preferably, the quick-change tool holder is provided to hold quick-change tools with a tool shaft which has at least one groove and/or at least one elevation which is/are provided for transmitting the torque and/or for fixing the quick-change tool in the quick-change tool holder. In particular, the quick-change tool holder is provided to hold SDS-plus® or SDS-Quick® quick-change tools or quick-change tools which have an SDS-plus® or SDS-Quick®-compatible quick-change tool shaft. The designations SDS® (register number DE 396086497), SDS-plus® (register number 395166950) and SDS-Quick® (register number 307557219) are registered trademarks of Robert Bosch GmbH.

In a preferred configuration of the invention, it is proposed that the product be less than 1001 cm³ kg A h⁻¹, by which means in particular advantageously balanced handiness, power and running time can be achieved.

In a particularly preferred configuration of the invention, it is proposed that the product be less than 751 cm³ kg A h⁻¹. In this way, in particular an especially advantageously balanced handiness, power and running time can be achieved.

Furthermore, the invention is based on a portable machine tool, in particular a hammer drill and/or chisel hammer, which has a length, a width, a height and a mass, having at least one energy storage unit which has a charge carrier capacity, and having a quick-change tool holder for quick-change tools with a shaft diameter of less than 20 mm, in particular of 18 mm.

It is proposed that a product formed from the length, the width, the height, the mass and the inverse of the charge carrier capacity be less than 20,001 cm³ kg A h⁻¹.

As a result of the configuration according to the invention of the portable machine tool, in particular good handleability can be achieved. Advantageously, a machine tool having a beneficial combination of size, weight and charge carrier capacity can be provided. In addition, high operating convenience can advantageously be achieved. In particular, a machine tool having advantageously balanced handiness and running time can be provided. Furthermore, a machine tool that can be handled conveniently and/or safely and/or precisely for tools with a medium shaft diameter can advantageously be provided.

In particular, the quick-change tool holder is provided to hold SDS-max® quick-change tools or quick-change tools which have an SDS-max®-compatible tool shaft. Preferably, the energy storage unit is provided for use with an operating voltage of 36 V. However, it is also conceivable that the energy storage unit is provided for use with an operating voltage of 9 V or 18 V or 24 V or another operating voltage appearing practical to one skilled in the art. The designation SDS-max® is a registered trademark of Robert Bosch GmbH (register number 395166969).

In a preferred configuration of the invention, it is proposed that the product be less than 15,001 cm³ kg A h⁻¹, by which means in particular advantageously balanced handiness, power and running time can be achieved.

In a particularly preferred configuration of the invention, it is proposed that the product be less than 10,001 cm³ kg A h⁻¹. In this way, in particular an especially advantageously balanced handiness, power and running time can be achieved.

Furthermore, the invention is based on a portable machine tool, in particular a hammer drill and/or chisel hammer, which has a length, a width, a height and a mass, having at least one energy storage unit which has a charge carrier capacity, and having a quick-change tool holder for quick-change tools with a shaft diameter of greater than 26 mm, in particular of 28 mm or of 30 mm.

It is proposed that a product formed from the length, the width, the height, the mass and the inverse of the charge carrier capacity be less than 100,001 cm³ kg A h⁻¹.

As a result of the configuration according to the invention of the portable machine tool, in particular good handleability can be achieved. Advantageously, a machine tool having a beneficial combination of size, weight and charge carrier capacity can be provided. In addition, high operating convenience can advantageously be achieved. In particular, a machine tool having advantageously balanced handiness and running time can be provided. Furthermore, a machine tool that can be handled conveniently and/or safely and/or precisely for tools with a large shaft diameter can advantageously be provided.

In particular, the quick-change tool holder is provided to hold SDS-hex quick-change tools or quick-change tools which have an SDS-hex-compatible tool shaft or quick-change tools which have a hexagonal tool shaft, in particular with at least one groove and/or at least one elevation, which is/are provided for transmitting a torque and/or for fixing the quick-change tool in the quick-change tool holder. Preferably, the energy storage unit is provided for use with an operating voltage of 36 V. However, it is also conceivable that the energy storage unit is provided for use with an operating voltage of 9 V or 18 V or 24 V or another operating voltage appearing practical to one skilled in the art.

In a preferred configuration of the invention, it is proposed that the product be less than 80,001 cm³ kg A h⁻¹, by which means in particular advantageously balanced handiness, power and running time can be achieved.

In a particularly preferred configuration of the invention, it is proposed that the product be less than 70,001 cm³ kg A h⁻¹. In this way, in particular an especially advantageously balanced handiness, power and running time can be achieved.

Furthermore, the invention is based on a method for manufacturing a portable machine tool, in particular a hammer drill and/or chisel hammer, which has a length, a width, a height, a mass, at least one energy storage unit with a charge carrier capacity, and a quick-change tool holder for quick-change tools.

It is proposed that the method have at least one method step, in which a product formed from the length, the width, the height, the mass and the inverse of the charge carrier capacity is taken into account to the effect that the product is less than a specific value, which depends on a shaft diameter for which the quick-change tool holder is designed.

By means of a method according to the invention, in particular good handleability can be achieved. Advantageously, a machine tool having a beneficial combination of size, weight and charge carrier capacity can be provided. Furthermore, high operating convenience can advantageously be achieved. In particular, a machine tool having advantageously balanced handiness and running time can be provided. Furthermore, a machine tool that can be handled conveniently and/or safely and/or precisely for tools with a large shaft diameter can advantageously be provided.

Advantageously, for quick-change tools with a shaft diameter of less than 12 mm, in particular of 10 mm or of 6.5 mm and/or for a quick-change tool with an SDS-plus® tool shaft or an SDS-Quick® tool shaft and/or for an SDS-plus®- or SDS-Quick®-compatible quick-change tool, the product is less than 1301 cm³ kg A h⁻¹, particularly advantageously less than 1001 cm³ kg A h⁻¹and preferably less than 751 cm³ kg A h⁻¹.

Advantageously, for quick-change tools with a shaft diameter of less than 20 mm, in particular of 18 mm, and/or for a quick-change tool with an SDS-max® tool shaft and/or for an SDS-max®-compatible quick-change tool, the product is less than 20,001 cm³ kg A h⁻¹, particularly advantageously less than 15,001 cm³ kg A h⁻¹ and preferably less than 10,001 cm³ kg A h⁻¹.

Advantageously, for quick-change tools with a shaft diameter of more than 26 mm, in particular of 28 mm or 30 mm, and/or for a quick-change tool with an SDS-hex tool shaft and/or for an SDS-hex-compatible quick-change tool and/or for a quick-change tool with a hexagonal tool shaft, the product is less than 100,001 cm³ kg A h⁻¹, particularly advantageously less than 80,001 cm³ kg A h⁻¹ and preferably less than 70,001 cm³ kg A h⁻¹.

Here, the portable handheld machine tool according to the invention is not intended to be restricted to the above-described application and embodiment. In particular, the hand-held machine tool according to the invention can have a number of individual elements, components and units deviating from a number cited herein in order to fulfill a function described herein.

### DRAWING

Further advantages can be gathered from the following drawing description. Three exemplary embodiments of the invention are illustrated in the drawing. The drawing, the description and the claims contain numerous features in combination. The person skilled in the art will expediently also consider the features individually and combine them to form practical further combinations.

In the drawing:

FIG. 1 shows a first portable machine tool in a schematic illustration,

FIG. 2 shows a second portable machine tool in a schematic illustration,

FIG. 3 shows a third portable machine tool in a schematic illustration, and

FIG. 4 shows an exemplary flowchart for a method for manufacturing a portable machine tool.

### DESCRIPTION OF THE EXEMPLARY EMBODIMENTS

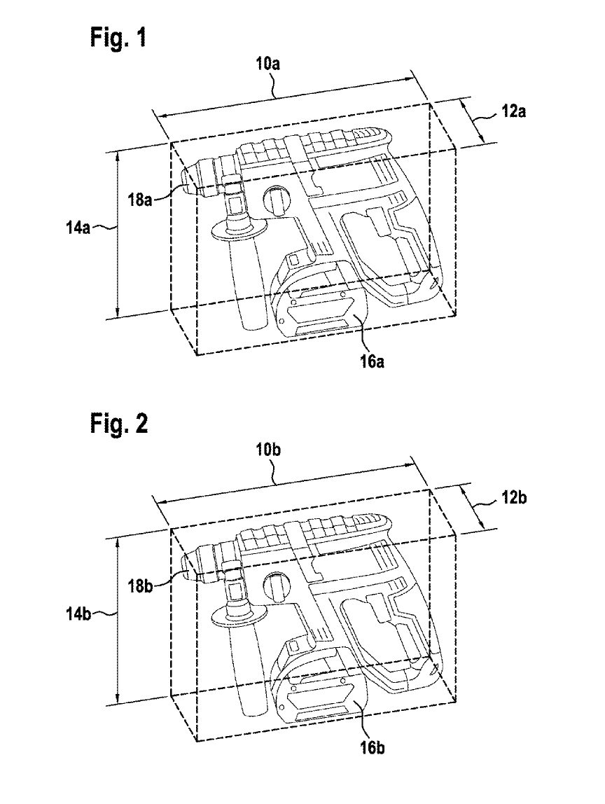

FIG. 1 shows a first portable machine tool formed as a battery-powered hand drill. The first portable machine tool has a quick-change tool holder 18a. In the present case, the quick-change tool holder 18a is provided to hold SDS-plus® quick-change tools with a shaft diameter of 10 mm. In addition, the first portable machine tool has a length (Lₐ) 10a, a width (Bₐ) 12a, a height (Hₐ) 14a and a mass (mₐ). In the present case, the length (Lₐ) 10a is 25 cm, the width (Bₐ) 12a is 7 cm, the height (Hₐ) 14a is 20 cm and the mass (mₐ) is 1.8 kg. Furthermore, the first portable machine tool has an energy storage unit 16a formed as a battery pack with a charge carrier capacity (Qₐ). In the present case, the charge carrier capacity (Qₐ) is 6 Ah. A product (Pₐ32 Lₐ·Bₐ·Hₐ·mₐ·Qₐ⁻¹) of the length (Lₐ) 10a, the width (Bₐ) 12a, the height (Hₐ) 14a, the mass (mₐ) and an inverse of the charge carrier capacity (Qₐ) in the present case is 1050 cm³ kg A h⁻¹.

A further exemplary embodiment of the invention is shown in FIG. 2. FIG. 2 shows a second portable machine tool formed as a battery-powered hammer drill. The second portable machine tool has a quick-change tool holder 18b. In the present case, the quick-change tool holder 18b is provided to hold SDS-max® quick-change tools with a shaft diameter of 18 cm. In addition, the second portable machine tool has a length (L_{b}) 10b, a width (B_{b}) 12b, a height (H_{b}) 14b and a mass (m_{b}). In the present case, the length (L_{b}) 10b is 48 cm, the width (B_{b}) 12b is 9 cm, the height (H_{b}) 14b is 26 cm and the mass (m_{b}) is 6.5 kg. Furthermore, the second portable machine tool has an energy storage unit 16b formed as a battery pack with a charge carrier capacity (Q_{b}). In the present case, the charge carrier capacity (Q_{b}) is 4 Ah. A product (P_{b}=L_{b}·B_{b}·H_{b}·m_{b}·Q_{b}⁻¹) of the length (L_{b}) 10b, the width (B_{b}) 12b, the height (H_{b}) 14b, the mass (m_{b}) and an inverse of the charge carrier capacity (Q_{b}) in the present case is 18,252 cm³ kg A h⁻¹.

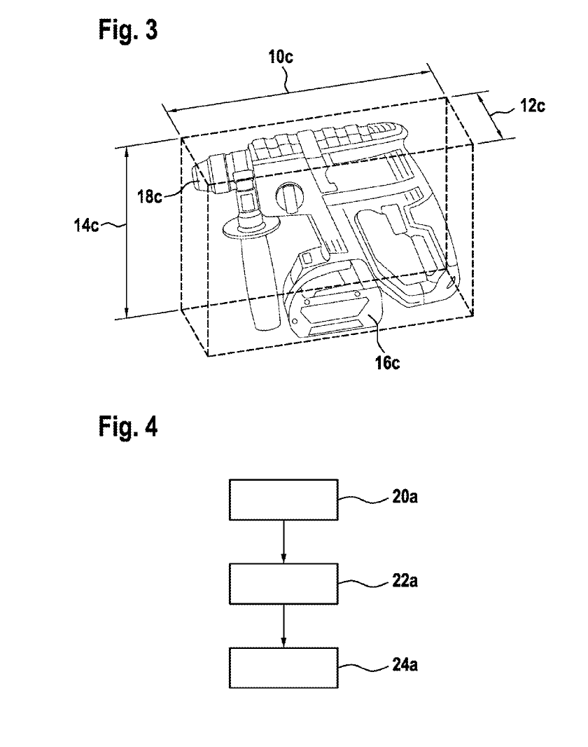

A further exemplary embodiment of the invention is shown in FIG. 3. FIG. 3 shows a third portable machine tool formed as a battery-powered hammer drill. The third portable machine tool has a quick-change tool holder 18c. In the present case, the quick-change tool holder 18c is provided to hold SDS-hex quick-change machine tools with a hexagonal tool shaft with a shaft diameter of 28 cm. In addition, the third portable machine tool has a length (L_{c}) 10c, a width (B_{c}) 12c, a height (H_{c}) 14c and a mass (m_{c}). In the present case, the length (L_{c}) 10c is 70 cm, the width (B_{c}) 12c is 25 cm, the height (H_{c}) 14c is 20 cm and the mass (m_{c}) is 16 kg. Furthermore, the portable machine tool has an energy storage unit 16c formed as a battery pack with a charge carrier capacity (Q_{c}). In the present case, the charge carrier capacity (Q_{c}) is 6 Ah. A product (P_{c}=L_{c}·B_{c}·H_{c}·m_{c}·Q_{c}⁻¹) of the length (L_{c}), the width (B_{c}), the height (H_{c}), the mass (m_{c}) and an inverse of the charge carrier capacity (Q_{c}) in the present case is 93,333 cm³ kg A h⁻¹.

FIG. 4 shows an exemplary flowchart of a method for manufacturing a portable machine tool having a length (L), a width (B), a height (H), a mass (M) and an energy storage unit with a charge carrier capacity (Q). In the present case, the first portable machine tool is manufactured (cf. FIG. 1). However, it is also conceivable that another machine tool is manufactured, in particular the second portable machine tool (cf. FIG. 2) or the third portable machine tool (cf. FIG. 3). In a first method step 20a, a check is made of the shaft diameter of a quick-change tool for which a quick-change tool holder of the portable machine tool is provided. In the present case, the quick-change tool holder 18a of the first portable machine tool is provided to hold SDS-plus® quick-change tools with a shaft diameter of 10 mm. In a second method step 22a, on the basis of the shaft diameter, it is determined which value a product (P) of the length (L), the width (B), the height (H), the mass (m) and the inverse of the charge carrier capacity (Q) is not to be exceeded. In the present case, the product (P) is to be less than 1301 cm³ kg A h⁻¹for shaft diameters which are smaller than 12 mm, is to be less than 20,001 cm³ kg A h⁻¹for shaft diameters which are less than 20 mm, and is to be less than 100,001 cm³ kg A h⁻¹for shaft diameters which are larger than 26 mm. In a third method step 24a, the length (L), the width (B), the height (H), the mass (m) and the charge carrier capacity (Q) are chosen in such a way that the product (P) is smaller than the corresponding value. In the present case, the length (Lₐ) 10a, the width (Bₐ) 12a, the height (Hₐ) 14a and the mass (mₐ) of the first portable machine tool and the charge carrier capacity (Qₐ) of the energy storage unit 16a of the first portable machine tool are chosen in such a way that the product (Pₐ) is 1050 cm³ kg A h⁻¹(cf. FIG. 1).

1. A portable machine tool, comprising:
a length, a width, a height and a mass;
at least one energy storage unit which has a charge carrier capacity; and
a quick-change tool holder configured to receive quick-change tools with a shaft diameter of less than 12 mm,
wherein a product formed of the length, the width, the height, the mass, and the inverse of the charge carrier capacity is less than 1301 cm³ kg A h⁻¹.

2. The portable machine tool as claimed in claim 1, wherein the product is less than 1001 cm³ kg A h⁻¹.

3. The portable machine tool as claimed in claim 2, wherein the product is less than 751 cm³ kg A h⁻¹.

4. A portable machine tool, comprising:
a length, a width, a height and a mass;
at least one energy storage unit which has a charge carrier capacity; and
a quick-change tool holder configured to receive quick-change tools with a shaft diameter of less than 20 mm,
wherein a product of the length, the width, the height, the mass, and the inverse of the charge carrier capacity is less than 20,001 cm³ kg A h⁻¹.

5. The portable machine tool as claimed in claim 4, wherein the product is less than 15,001 cm³ kg A h⁻¹.

6. The portable machine tool as claimed in claim 5, wherein the product is less than 10,001 cm³ kg A h⁻¹.

7. A portable machine tool, comprising:
a length, a width, a height, and a mass;
at least one energy storage unit which has a charge carrier capacity;
a quick-change tool holder configured to receive quick-change tools with a shaft diameter greater than 26 mm,
wherein a product of the length, the width, the height, the mass, and the inverse of the charge carrier capacity is less than 100,001 cm³ kg A h⁻¹.

8. The portable machine tool as claimed in claim 7, wherein the product is less than 80,001 cm³ kg A h⁻¹.

9. The portable machine tool as claimed in claim 8, wherein the product is less than 70,001 cm³ kg A h⁻¹.

10. A method for manufacturing a portable machine tool which has a length, a width, a height, a mass, at least one energy storage unit with a charge carrier capacity, and a quick-change tool holder configured to receive quick-change tools, the method comprising:
determining a specific value based on a shaft diameter of the quick-change tools which the quick-change tool holder is configured to receive;
configuring the length, the width, the height, the mass, and the inverse of the charge carrier capacity such that a product of the length, the width, the height, the mass, and the inverse of the charge carrier capacity is less than the specific value.

11. The portable machine tool of claim 1, wherein the portable machine tool is at least one of a hammer drill and chisel hammer.

12. The portable machine tool of claim 4, wherein the portable machine tool is at least one of a hammer drill and a chisel hammer.

13. The portable machine tool of claim 7, wherein the portable machine tool is at least one of a hammer drill and a chisel hammer.

14. The method of claim 10, wherein the portable machine tool is at least one of a hammer drill and a chisel hammer.
